(19) United States
(12) Patent Application Publication
(10) Pub. No.: US 2012/0043980 A1
(43) Pub. Date: Feb. 23, 2012

(54) WEAR SENSOR

(75) Inventor: Brian Davies, Western Australia (AU)

(73) Assignee: BRIAN INVESTMENTS PTY LTD, Esperance, Western Australia (AU)

(21) Appl. No.: 13/203,527

(22) PCT Filed: Feb. 25, 2010
(86) PCT No.: PCT/AU10/00219

§ 371 Date: Nov. 8, 2011

(30) Foreign Application Priority Data
Feb. 27, 2009 (AU) 2009900897

(51) Int. Cl. G01N 27/04

(52) U.S. Cl. 324/693

(57) ABSTRACT

A wear sensor comprises an electric circuit supported on a substrate. The circuit comprises a plurality of discrete elements which are coupled in parallel with each other across conductive rails. The circuit is electrically connected with a measuring device. The measuring device measures an electrical characteristic of the circuit such as resistance. The sensor is disposed in or adjacent an object which is subject to wear and wears with the object. As the sensor wears, the elements are sequentially decoupled from the circuit thereby changing the characteristic measured by the device. This change provides an indication of the amount of wear of the object.

### FIELD OF THE INVENTION

The present invention relates to sensors for detecting wear.

### BACKGROUND OF THE INVENTION

Plant and equipment in many industries are subject to wear by the passage or flow of abrasive materials. For example in mining, ore may be passed through chutes onto conveyors for subsequent processing. These chutes are subject to substantial wear by the passage of large, heavy and hard rocks. To extend the service life of such plant and equipment it is known to fix sacrificial wear plates to the surfaces which would otherwise be in contact with the abrasive material. Irrespective of whether or not wear plates are used, in order to optimally manage and maintain the plant and equipment it is common practice to monitor for wear. This may be done by manual inspection or by the use of sensors. In some situations where manual inspection is physically impossible or requires substantial down time, the use of sensors is the only viable option.

### SUMMARY OF THE INVENTION

According to one aspect of the invention there is provided a wear sensor comprising:

an electrical circuit comprising a plurality of discrete elements, each element contributing to a measurable electrical characteristic of the circuit; each element being capable of being electrically decoupled from the circuit by action of wear on the sensor, such that when wear occurs on the sensor one or more of the elements are electrically decoupled thereby changing the measurable electrical characteristic.

The wear sensor may comprise a substrate which is capable of being disposed along a path subject to wear and wherein the circuit is supported by the substrate.

The elements may be connected at different locations in the circuit such that the elements are sequentially decoupled from the circuit as wear progresses along the path.

The circuit may comprise two conductors supported by the substrate wherein the elements are electrically shunted across the conductors to form a parallel connection between the elements.

The substrate may comprise a circuit board and the two conductors comprise respective conductive tracks.

The two conductors may be embedded in or sandwiched between two nonconductive layers of material.

In one embodiment the circuit board is a composite circuit board comprising a first board and a second board which are arranged one on top the other and wherein the conductive tracks extend between the first and second boards.

In one embodiment each element has the same nominal electrical characteristic, e.g. the same resistance, or capacitance or inductance.

In the same or an alternate embodiment the elements are arranged in a plurality of groups, with each element in each group having the same nominal electrical characteristic.

In a further embodiment the elements are located along the wear path so that elements of one value of nominal electrical characteristic are electrically decoupled from the circuit due to action of wear on the sensor before elements of a second different value of a same nominal electrical characteristic are electrically decoupled by the action of wear on the sensor.

In an embodiment the plurality of elements comprises at least three elements which are arranged along the wear path with progressively reduced spacing of respective connections to the circuit in a direction of increased wear.

One or more of the elements may be a surface mount electronic component or a thick film printed element.

In one embodiment electrical elements are resistors.

In one possible arrangement the sensor may comprise a first portion and a second portion and the elements are supported on the second portion and are electrically coupled in the circuit by respective conductors that extend along the first portion such that as the sensor wears the respective conductors are worn away thereby electrically decoupling the respective elements from the circuit.

In this arrangement the first and second portions are configured to be selectively connectable together wherein the first portion is a sacrificial portion which wears away and the second portion is disposed outside of the wear path.

A second aspect of the invention provides a wear sensing system comprising:

one or more wear sensors according to the first aspect of the invention, the or each wear sensor capable of being disposed in or along a wear path of an object subject to wear; and,

one or more measuring devices for measuring the electrical characteristic of the or each sensor.

The wear sensing system may comprise a processor for processing the measured characteristic for the or each sensor and controlling the activation of sensory alarm when the measured characteristic of at least one of the sensors reaches a value indicative of a target amount of wear of the object.

The wear sensing system may comprise a visual display controlled by the processor to provide a visual representation of wear of the object.

A third aspect of the invention provides a method of sensing wear occurring to an object comprising:

measuring an electrical characteristic of a circuit of a wear sensor located in the object at a location subject to wear, wherein the circuit comprises a plurality discrete of elements, wherein the sensor is arranged so that the elements are sequentially electrically decoupled from the circuit due to wear of the wear sensor, each element contributing to a measurable electrical characteristic of the circuit, so that as wear occurs to the object and thus the wear sensor, one or more of the wear elements are electrically decoupled, thereby changing the measurable electrical characteristic.

In an embodiment repeated measurements are taken over time so that changes in the electrical characteristic are reflected in the measurements.

In an embodiment the changes in the electrical characteristic are used to determine the extent of wear to the object.

### BRIEF DESCRIPTION OF THE DRAWINGS

In order to provide a better understanding of the present invention, embodiments of the invention are described, by way of example only, with reference to the accompanied drawings, in which:

FIG. 1 is a schematic representation of a bolt securing a wear plate to a structure in which is disposed a wear sensor according to an embodiment of the present invention;

FIG. 2 is a perspective view of an embodiment of a wear sensor according to the present invention;

FIG. 3 is a perspective view of the wear sensor of FIG. 2 having been subjected to wear;

FIG. 4 is a schematic circuit diagram of the embodiment of the present invention;

FIG. 5 is a schematic representation of a second embodiment of the wear sensor;

FIG. 6 is a schematic block diagram of a wear system according to an embodiment of the present invention;

FIG. 7 is a graph representing measurements taken from a plurality of wear sensors according to an embodiment of the present invention;

FIG. 8 is a schematic representation of a circuit diagram for a further embodiment of the wear sensor; and,

FIG. 9 is a schematic circuit diagram of a further embodiment of the wear sensor.

### DETAILED DESCRIPTION OF PREFERRED EMBODIMENTS

In one embodiment a wear sensor comprises a substrate supporting a plurality of electrical elements connected in a parallel configuration. The substrate is intended to be disposed so as to wear away with a surface of an object being monitored for wear. Wear occurs simultaneously to the surface and an end of the substrate adjacent the surface. This results in the progressive removal and thus electrical decoupling (or open circuiting) of the electrical elements and consequently a change in an electrical characteristic to a circuit formed by the parallel elements. The change of the electrical characteristic can be measured and is reflective of the extent of wear to the wear sensor and thus the surface being monitored. Indeed the change in electrical characteristic can be calibrated to the amount of wear of the surface in terms of a distance or thickness (eg a measure in mm) or as a percentage of the total thickness of the surface.

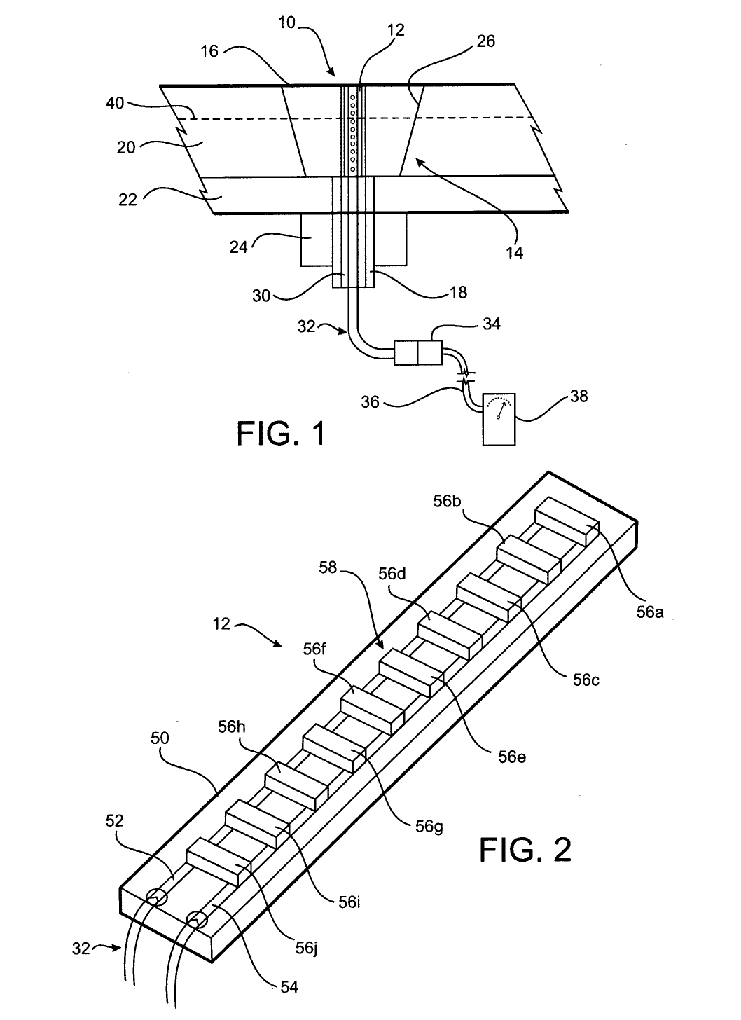

FIG. 1 shows an example of a wear sensor system 10. In this example there is an object in the form of a wear plate 20, which is subject to wear. The wear plate 20 is secured by a fastener 14 to a structural element 22. The fastener 14 is in the form of a bolt having a head 16 and shaft 18. The head 16 locates in a complementary shaped recess in the wear plate 20. A nut 24 threadingly engages with the shaft 18 so that the wear plate 20 is secured to the structural element 22 by applying a clamping force between the head 16 and the nut 24.

Inside the head 16 and shaft 18 is a passage 30 which extends through the length of the bolt 14. An embodiment of a wear sensor 12 is disposed within the passage 30. This coincides with a wear path for the wear plate 20 and bolt 14. Extending from the wear sensor 12 are wires 32 which exit the shaft 18 and are connected by connector 34 to a communication lead 36. The communication lead 36 would usually be wired to a junction box, although it could be connected to a wireless communication device, and then to a measuring device 38.

The surface of the wear plate 20 and bolt 16 and the end of the wear sensor 12 adjacent these surfaces are subjected to wear. In time these surfaces and the end of the sensor 12 will wear down to the dashed line 40. All of the material above the line 40 will have been worn away (i.e. removed) including part of the wear plate 20, part of the head 16 and part of the wear sensor 12. Assuming that there is one or more electrical elements or at least connections of those elements to the circuit on the part of the sensor that has been worn away then such elements will have also be worn away or otherwise electrically decoupled or open circuited form the electrical circuit to which they were previously parallel connected.

FIG. 2 shows the wear sensor 12 in more detail. The wear sensor 12 comprises a substrate in the form of a printed circuit board (PCB) 50 which has a pair of tracks 52 and 54 extending along its length. In an embodiment the tracks 52 and 54 are parallel to each other. Spaced apart along the length of the PCB 50 is a plurality of elements 56. The elements 56 are placed so as to be in electrically shunted across the tracks 52 and 54. In this arrangement the elements 56 are electrically connected in parallel. The elements 56 in one example are surface mount components such as surface mount resistors or thick film resistors which are printed onto the PCB 50. However, in other embodiments the elements 56 may be other types of electrical components such as capacitors, inductors, semiconductors or combinations of these. Connected to and extending from each of the tracks 52 and 54 are a respective one of the wires 32.

The arrangement of parallel elements 56 connected between the tracks 52 and 54 form an electrical circuit 58 having a measurable electrical characteristic determined by the elements 56. In the case of the elements being resistors, the electrical characteristic will be the total resistance resulting from each of the resistors being in a parallel arrangement. Alternatively another electrical characteristic (for example voltage or current) may be determined that is directly related to the resulting resistance. The electrical characteristic is measurable from the wires 32. The total resistance R of the circuit 58 is calculated as:

R=1÷((1÷R₁)+(1÷R₂) . . . (1÷Rn)),

where R₁, . . . Rn is the resistance value of each of n resistors connected to the circuit at any one time.

The resistance can be measured by an ohmmeter. Alternatively the current or voltage can be measured, where the voltage or current (respectively) is known, and the resistance R calculated by the well known formula V=IR, where V is the voltage across the tracks 52 and 54 and I is the current through one of the wires 32.

In the case of the elements being capacitors the capacitance of the set of elements 56 will be the sum of the capacitance of each element 56.

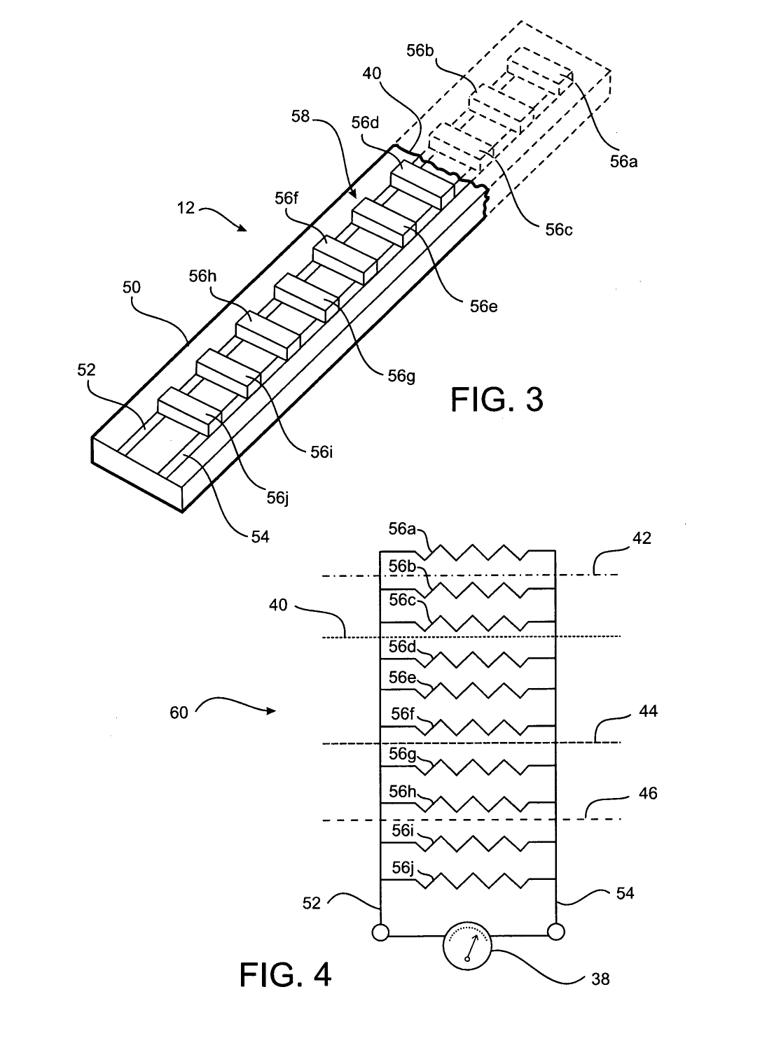

FIG. 3, illustrates the PCB 50 of FIG. 2 but when worn down to the level 40 shown in FIG. 1. The worn away portion is shown in phantom line. This indicates that three elements 56a, 56b and 56c (resistors in this embodiment) have been removed or decoupled from the circuit 58 which now comprise the remaining seven resistors 56d-56j connected in parallel with each other. The removal/decoupling of the three resistors 56a-56c will change the total resistance of the circuit. This change is measured and can be calibrated with actual depth of wear of the wear plate 20 and bolt 14 so that the change in resistance gives a quantifiable measure of depth of wear.

A circuit diagram 60 of the circuit 58 is shown in FIG. 4. Elements 56a, 56b, 56c, 56d, 56e, 56f, 56g, 56h, 56i and 56j are connected in parallel by being shunted across the tracks 52 and 54. The electrical characteristic is measured by measuring device 38. The measuring device may be an ohmmeter, or more preferably a voltmeter where a known current enters either track 52 or 54 from one of the wires 32, or an ammeter where a known voltage is applied across the tracks 52 and 54. The measuring device can take other forms depending on the nature of the elements, for example, a capacitance meter, or a frequency meter.

Various examples of amounts of wear are shown, for example by lines 40, 42, 44 and 46. In the case of line 42, the wear sensor 12 is worn to the point where resistor 56a is removed. The resistance of the circuit would be determined by the remaining resistors i.e. 56b-56j. In the case of wear being at line 40, the resistance of the circuit would be as calculated by the value of resistors 56d-56j. When the wear is at the extent of line 44 the value of the resistance of the circuit would be as calculated by the values of the resistors 56g-56j. When the extent of wear is at the line indicated by line 46, the value of the resistance of the circuit would be calculated by resistors 56i and 56j. Other combinations are omitted for brevity.

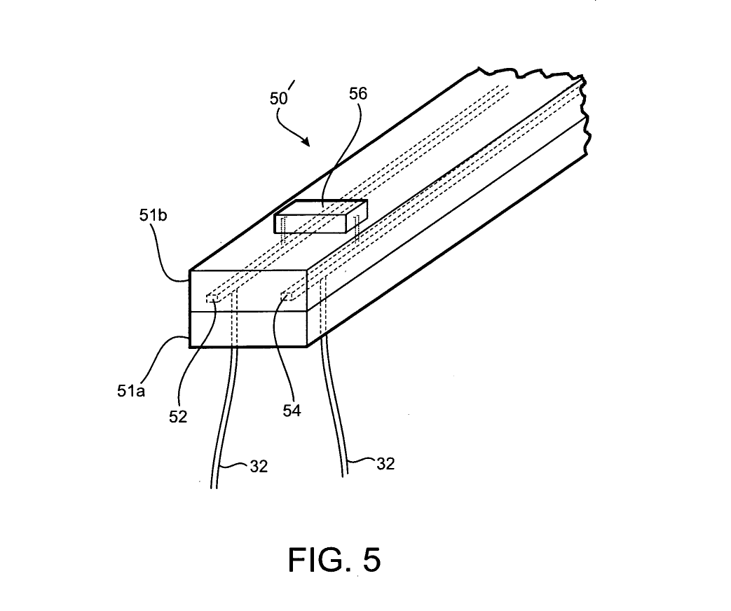

FIGS. 2 and 3 schematically represent the tracks 50 and 52 as being laid or printed onto of a printed circuit board 50 with the elements 56 electrically coupled across the tracks 52 and 54. However in an alternate embodiment, in order to minimise the risk of short circuiting of the circuit 58 for example by a conductive material spanning across the tracks 52 and 54, the tracks 52 and 54 may be embedded in or sandwiched between two nonconductive layers. For example, the printed circuit board 50 may be in the form of a composite circuit board formed from first and second circuit boards which are arranged one on top of the other and where the conductive tracks 52 and 54 extended between the first and second boards. This is illustrated schematically in FIG. 5 which shows the printed circuit board 50′ which is composed of first and second boards 51a and 51b which are arranged one on top of the other. The tracks 52 and 54 are printed on a face of the circuit board 51a which contacts an opposing face of the circuit board 51b of the composite PCB 50′. Thus the tracks 52 and 54 are in effect sandwiched between the two boards 51a and 51b together which form a nonconductive layer surrounding or wholly encasing the tracks 52 and 54. The leads 32 can electrically contact the tracks 52 and 54 by use of conventional through hole coupling. The components 56 may either be surface mounted on say the first board 51b to electrically couple between the tracks 52 and 54; or alternately, the elements 56 may themselves be sandwiched between the two boards 51a and 51b. Providing the elements 56 as thick film print elements may be particularly suited to such an embodiment.

With reference to FIG. 2, a similar structure may be obtained by overlaying the surface of the board 50 containing the tracks 52 and 54 and the elements 56 with a nonconductive layer of material which is adhered thereto. This may also be achieved by encapsulating the printed circuit board 50 in a conventional epoxy resin encapsulant typically used in the electronics industry for the encapsulation of electronic circuits and components.

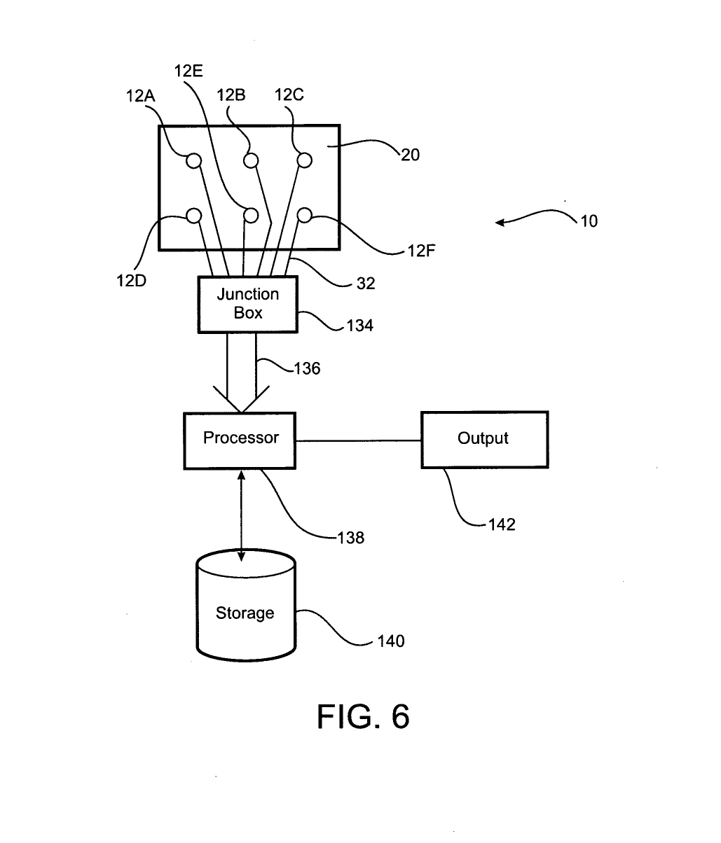

FIG. 6 shows an alternative example of a wear sensor system 10, which has a plurality of wear sensors 12a-12f installed at different locations in the object 20 subject to wear. Each sensor 12a-12f has wires 32 leading to a junction box 134. In one embodiment the junction box 134 connects the wires 32 to a cable 136 which in turn is connected to a processor 138. In another embodiment the junction box 134 includes a measuring device which measures the electrical characteristic of each of the wear sensors 12a-12f as described above. This measurement may then be transferred as an analogue signal via cables 136 or may be converted into a digital signal and sent across cables 136 in the form of a bus to the processor 138.

The processor 138 in one embodiment measures the electrical characteristic provided by the cable 136 or receives a signal representing the measurements from the measurement device in the junction box. The processor 138 in one embodiment is configured to store each of the measurements in a storage device 140. The processor 138 may also be arranged to compare each of the measurements to a threshold. When the threshold is reached the processor 138 activates an output device 142 which can comprise some type of sensory alert such as an audible siren or a visual alarm (e.g. turning an extinguished light ON or flashing a light).

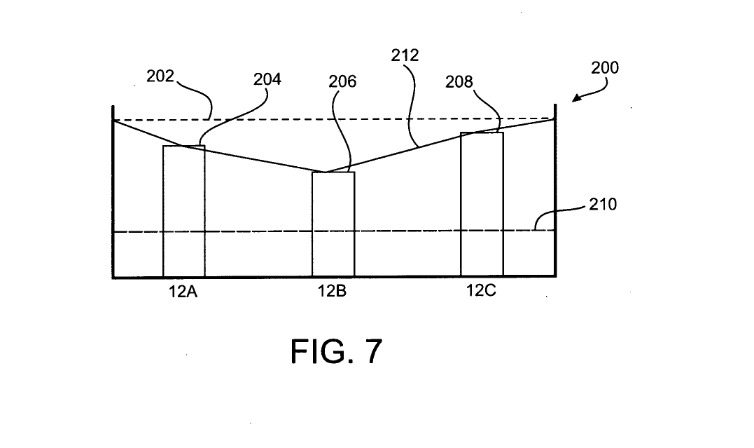

In one embodiment the processor 138 includes measuring circuitry. Typically the processor 138 is on the form of a computer comprising a microprocessor operated under the control of the instructions of a computer program. The computer program is typically stored in a computer readable storage medium such as a memory, flash drive, CD, DVD, hard disc drive etc. The storage device 140 may be for example a memory flash drive, hard disc drive, network storage etc. The output device 142: in addition, or as an alternate, to providing some type of sensory alert; may be controlled by the processor 138 to provide a visual representation on a display 200 (shown in FIG. 7) of the measurements taken from each of the wear sensors over time or an instantaneous view of the extent of wear that has occurred to each of the wear sensors.

FIG. 7 provides an example of an image on the visual display 200 of the extent of wear occurring to wear sensors 12a, 12b and 12c from FIG. 6. The image on the visual display 200 is in the form of a graph. The graph includes a dashed line 202 which indicates the starting level of each of the wear sensors 12a-12c. At a given point in time the extent of wear to each of the wear sensors 12a-12c is determined and graphically represented by the drop in the height of the bars 204, 206 and 208 respectively from line 202. In other words the height of the bars reflects the number of elements remaining on each sensor 12a-12c. Another dashed line 210 represents a threshold level, which if crossed will trigger an alarm indicating that the extent of wear to the object, such as a wear plate, is at a safe working limit and needs to be replaced. Solid line 212 represents an approximation of the surface profile of the object 20 according to the individual heights of bars 204, 206, 208 and the extremities of the object 20.

In an alternate embodiment a more sophisticated form of graphical representation can be provided. For example a three dimensional representation could be provided by also providing bars representing the extent of wear to 12d, 12e and 12f. Indeed a three dimensional relief map may be constructed from the output of sensors 12 to provide a visual representation of the geometry of the surface of the object 20.

The extent of wear that has occurred is the difference between line 202 and the height of the respective bar. This difference can be shown as an amount above the base of the graph, rather than as a drop from the line 202. Other forms of data visualisation can be provided, such as slices through selected wear sensors.

Rate of wear with the respect to time can be calculated and used to extrapolate when the wear will reach a particular threshold. Furthermore deviations from the expected rate can also be determined and used to extrapolate, for example, the hardness of material or some other property of the material to which the object 20 is exposed.

In order to provide greater sensitivity as wear progresses to a critical level the contribution of the electrical elements to the measured electrical characteristic of the circuit can be varied with distance from the surface of the object 20 (prior to wear). For example the contribution by each of the elements may be grouped with each contribution in the group according to one criterion, such as them all being the same resistance or being linear within the group. The contribution of each of the elements within another group can meet another criteria, such as for example their contribution being linear but at a different rate or being exponential, or meeting some other criteria.

Furthermore the location of each of the elements along a wear path of each wear sensor may be equally spaced or may be spaced differently, according to the position of the element within the wear path. For example a higher level of granularity may be required as the amount of wear reaches a critical level. Consequently the spacing made of elements may be closer together at a certain position within the wear path than the spacing of the elements at another position.

When the elements are resistors, to accommodate the change in resistance as elements in one example the resistors can be arranged so that resistors with a lower resistance are worn away before higher values of resistance are worn away. For some implementations, this produces a more effective change in the value of the resistance of a circuit as the elements are worn away.

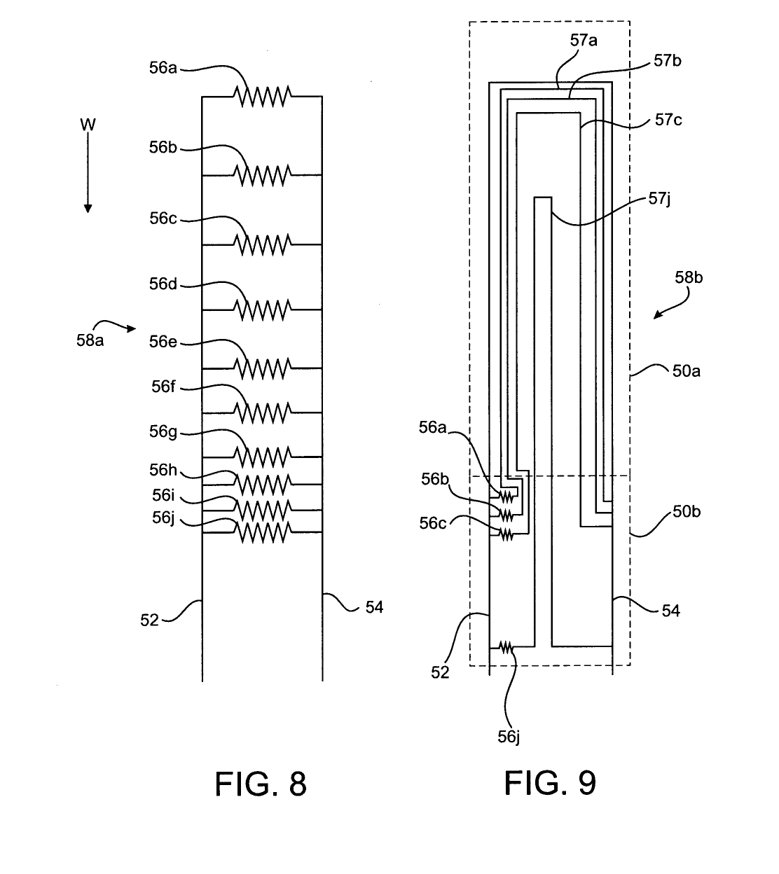

The length of the wear sensor 12 can be as anticipated required according to the thickness of the object being measured that is, the length of the wear path. Furthermore the spacing of the elements or their connection in the circuit 58 need not be uniform. For example as the amount of wear increases, higher granularity may be required, thus the elements may be closer to each other in a region within which the amount of wear becomes critical. An example of this is illustrated schematically in FIG. 8 which shows an embodiment of an electric circuit 58a where the electrical components 56a-56j are progressively closer together in a direction of wear W of the objection which is subject to wear and being monitored by a wear sensor comprising the circuit 58a. Thus in this example, the electrical element 56a is the first of the elements that will electrically decoupled from a circuit 58a as wear progresses. The element 56j will be the last element removed or electrically decoupled. Further, the spacing between any three consecutive elements progressively decreases. For example, looking at elements 56b, 56c and 56d, the spacing between elements 56c and 56d is smaller than the spacing between elements 56b and 56c. The smallest spacing is between the lines 56i and 56j. Thus as wear increases, there is a increased rate of change in the measured electrical characteristic (in this case total resistance) of the circuit 58a.

The value of the electrical elements may be grouped so that the value of the change of resistance changes according to a desired function of the extent of wear. The value of the resistors may be selected so that the change in the resistance is substantially linear. The wear sensor 12 is inserted into the head 16 and any air gaps may be filled by a non-conductive filler.

The wear sensor may be used to measure the extent of wear to an object along a path which need not extend into the object. Instead the path may be for example across a surface of the object.

FIG. 9 illustrates an alternate circuit 58b which may be incorporated in another embodiment of the wear sensor. In this embodiment, the circuit 58b comprises electrical elements 56a-56j and the conductive tracks 52 and 54. However, the geometry or configuration of the connection of the elements 56 between the tracks 52 and 54 is different. In this embodiment, one end of each element 56 has a first short lead or conductor that is connected to the track 52, while an opposite end of the elements 56a-56j have long leads or conductors 57a-57j respectively (hereinafter referred to in general as “conductor 57”) which follow a rectangular like path to connect at an opposite end to the track 54. In this embodiment, the conductor 57 of each of the elements 56 may for example be printed conductive tracks on a portion of a print circuit board 50. Furthermore, the circuit board 50 can comprise a first portion 50a which carries the substantive length of the tracks 57, and a second portion 50b that carries the components 56. The sensor can be arranged so that, with reference to FIG. 1 the portion 50a is disposed in a portion of the passage 30 which extends through the head 16 of the fastener 14 while the second portion 50b in a part of the passage 30 within the shank 18 of the fastener 14. In this embodiment, as wear progresses, the conductors 57 are progressively worn away thereby electrically decoupling the elements 56 from the circuit 58b although the elements 56 themselves are never subject to wear. This provides the possibility of forming the printed circuit board and the circuit 58 as two components, a first sacrificial component comprising the conductors 57 on portion 50a, and a second reusable component or portion which comprises the resistive elements 56 on portion 50b. In this embodiment the first and second portions 50a and 50b can be electrically and physically selectively connectable together by means of pins and sockets. Indeed the connection may be for example by a ribbon cable so that the second portion is located distant or remote from the object 20.

Modifications and variations as would be apparent to a person skilled in the art are deemed to be within the scope of the present invention the nature of which is to be determined by the above description and the appended claims.

1. A wear sensor comprising:
an electrical circuit comprising a plurality of discrete elements, each element contributing to a measurable electrical characteristic of the circuit; each element being capable of being electrically decoupled from the circuit by action of wear on the sensor, such that when wear occurs on the sensor one or more of the elements are electrically decoupled thereby changing the measurable electrical characteristic.

2. The wear sensor according to claim 1 comprising a substrate which is capable of being disposed along a path subject to wear and wherein the circuit is supported by the substrate.

3. The wear sensor according to claim 2 wherein the elements are connected at different locations in the circuit such that the elements are sequentially decoupled from the circuit as wear progresses along the path.

4. The wear sensor according to claim 1, wherein the circuit comprises two conductors supported by the substrate and the elements are electrically shunted across the conductors to form a parallel connection between the elements.

5. The wear sensor according to claim 4 wherein the substrate comprises a circuit board and the two conductors comprise respective conductive tracks.

6. The wear sensor according to claim 5 wherein the two conductors are embedded in or sandwiched between two nonconductive layers of material.

7. The wear sensor according to claim 6 wherein the circuit board is a composite circuit board comprising a first board and a second board which are arranged one on top the other and wherein the conductive tracks extend between the first and second boards.

8. The wear sensor according to claim 7 wherein each element has the same nominal electrical characteristic.

9. The wear sensor according to claim 7 wherein the elements are arranged in a plurality of groups, with each element in each group having the same nominal electrical characteristic.

10. The wear sensor according to claim 7 wherein the elements are located along the wear path so that elements of one value of electrical characteristic are electrically decoupled from the circuit due to action of wear on the sensor before elements of a second different value of a same electrical characteristic are electrically decoupled by the action of wear on the sensor.

11. The wear sensor according to claim 7 wherein the plurality of elements comprises at least three elements which are arranged along the wear path with progressively reduced spacing of respective connections to the circuit in a direction of increased wear.

12. The wear sensor according to claim 1, wherein each element is a surface mount electronic component or a thick film printed element.

13. The wear sensor according to claim 1, wherein the electrical elements are resistors.

14. The wear sensor according to claim 2, wherein the substrate comprises a first portion and a second portion and the elements are supported on the second portion and are electrically coupled in the circuit by respective conductors that extend along the first portion such that as the sensor wears the respective conductors are worn away thereby electrically decoupling the respective elements from the circuit.

15. The wear sensor according to claim 14 wherein the first and second portions are configured to be selectively connectable together wherein the first portion is a sacrificial portion which wears away and the second portion is disposed outside of the wear path.

16. A wear sensing system comprising:
one or more wear sensors according to claim 1, the or each wear sensor capable of being disposed in or along a wear path of an object subject to wear; and,
one or more measuring devices for measuring the electrical characteristic of the or each sensor.

17. The wear sensing system according to claim 15 comprising a processor for processing the measured characteristic for the or each sensor and controlling the activation of sensory alarm when the measured characteristic of at least one of the sensors reaches a value indicative of a target amount of wear of the object.

18. The wear sensing system according to claim 16, comprising a visual display controlled by the processor to provide a visual representation of wear of the object.

19. A method of sensing wear occurring to an object comprising:
measuring an electrical characteristic of a circuit of a wear sensor located in the object at a location subject to wear, wherein the circuit comprises a plurality of discrete elements, wherein the sensor is arranged so that the elements are sequentially electrically decoupled from the circuit due to wear of the wear sensor, each element contributing to a measurable electrical characteristic of the circuit, so that as wear occurs to the object and thus the wear sensor, one or more of the wear elements are electrically decoupled, thereby changing the measurable electrical characteristic.

20. The method according to claim 19 comprising:
forming the circuit on a substrate;
forming holes in the object which runs along a path of wear of the objection; and,
disposing the substrate in the hole.
